(19) United States
(12) Patent Application Publication
(10) Pub. No.: US 2026/0140671 A1
(43) Pub. Date: May 21, 2026

(54) IMAGE FORMING APPARATUS, CONTROL METHOD FOR IMAGE FORMING APPARATUS, AND STORAGE MEDIUM

(71) Applicant: CANON KABUSHIKI KAISHA, Tokyo (JP)

(72) Inventor: YUTAKA INOUE, Tokyo (JP)

(21) Appl. No.: 19/386,778

(22) Filed: Nov. 12, 2025

(30) Foreign Application Priority Data
Nov. 20, 2024 (JP) 2024-202615

(51) Int. Cl. G06F 3/12

(52) U.S. Cl. CPC G06F 3/1205; G06F 3/1208; G06F 3/1219; G06F 3/1231; G06F 3/1238; G06F 3/125; G06F 3/1253; G06F 3/1285

(57) ABSTRACT

An image forming apparatus comprising: one or more memory devices that store a set of instructions; and one or more processors that execute the set of instructions to: receive, from an information processing apparatus, an image formation instruction to form an image including a region in which a setting related to image formation is selectable; form the image on a sheet based on the image formation instruction; obtain, from the region, a setting selected by a user in the region on the sheet on which the image was formed; transmit the obtained setting to the information processing apparatus; receive, from the information processing apparatus, another image formation instruction in which the transmitted setting was reflected; and form the image on another sheet based on the received other image formation instruction.

### BACKGROUND

### Field of the Technology

The present disclosure relates to an image forming apparatus, a control method for an image forming apparatus, and a storage medium.

### Description of the Related Art

A home learning system that utilizes remote printing has been developed. In such a home learning system, a school, cram school, or the like sends assignment data to a scanner-equipped printer at a student's home. The student then prints out the assignment on their home printer and writes their answers on the printed sheet. The student then scans the answer sheet with a scanner and transmits the answer data to the school or cram school. In such a system, the print settings used when printing the assignment are set by the sending school or cram school. Also, in Japanese Patent Laid-Open No. 2015-138495, it is described that print settings are changed on a panel of the printer. It is also described that changes to print settings in the server are reflected in the print job, and the print job is transmitted to the printer.

In the technology disclosed in Japanese Patent Laid-Open No. 2015-138495, it is difficult for people with little knowledge of changing print settings, such as students, to change the print settings. In addition, there is a possibility that a printing problem will occur if the student operates the printer incorrectly.

### SUMMARY

The present disclosure enables realization of a mechanism that enables a user to easily change settings related to image formation by selecting them in a region of a sheet on which an image has been formed.

One aspect of the present disclosure provides an image forming apparatus comprising: one or more memory devices that store a set of instructions; and one or more processors that execute the set of instructions to: receive, from an information processing apparatus, an image formation instruction to form an image including a region in which a setting related to image formation is selectable; form the image on a sheet based on the image formation instruction; obtain, from the region, a setting selected by a user in the region on the sheet on which the image was formed; transmit the obtained setting to the information processing apparatus; receive, from the information processing apparatus, another image formation instruction in which the transmitted setting was reflected; and form the image on another sheet based on the received other image formation instruction.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an image forming system according to an embodiment.

FIG. 2 is a hardware configuration diagram of an image forming apparatus according to an embodiment.

FIG. 3 is a hardware configuration diagram of a server and a client PC according to an embodiment.

FIG. 4 is a functional block diagram of a server according to an embodiment.

FIG. 5 is a functional block diagram of a client PC according to an embodiment.

FIG. 6 is a functional block diagram of an image forming apparatus according to an embodiment.

FIG. 7 is a schematic diagram of an operation panel of an image forming apparatus according to an embodiment.

FIG. 8 is a diagram showing a structure of a database according to an embodiment of the present disclosure.

FIG. 9 is a diagram showing a configuration of a database according to an embodiment.

FIG. 10 is a schematic diagram of print content according to an embodiment.

FIG. 11 is a schematic diagram of a check form for changing print settings according to an embodiment.

FIG. 12 is a schematic diagram of print content according to an embodiment.

FIGS. 13A and 13B are flowcharts of processing according to an embodiment.

FIG. 14 is a flowchart of processing according to an embodiment.

FIG. 15 is a functional block diagram of an image forming apparatus according to an embodiment.

FIG. 16 is a flowchart of processing according to an embodiment.

FIGS. 17A and 17B are flowcharts of processing according to an embodiment.

FIG. 18 is a flowchart of processing according to an embodiment.

FIG. 19 is a schematic diagram of print settings according to an embodiment.

FIG. 20A is a schematic diagram of print content according to an embodiment.

FIG. 20B is a schematic diagram of print content according to an embodiment.

FIG. 21 is a schematic diagram of a check form for changing print settings according to an embodiment.

FIG. 22 is a flowchart of processing according to an embodiment.

FIG. 23 is a flowchart of processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In this specification, the term “image forming apparatus” broadly includes apparatuses that form (record) images on recording materials (recording media), such as single-function printers, copying machines, multifunction printers, and commercial printing machines. The image forming apparatus may also be a system (image forming system) in which an image forming apparatus main body that forms an image on a recording material is connected to devices such as a sheet processing apparatus and a sheet feeding apparatus. In addition, the term “printing” used hereinafter includes printing through an inkjet method and printing through a toner method.

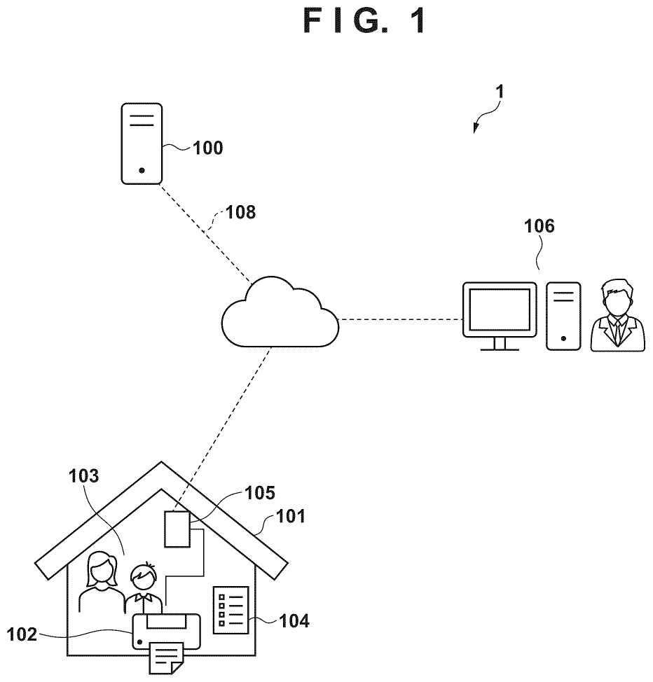

An image forming system 1 according to the embodiment will be described with reference to FIG. 1. The image forming system 1 includes a server 100, a client PC 106 operated by an operator 107 belonging to a school or a business, and an input/output device 102 such as a multifunction printer in a student's home 101. These apparatuses are connected to each other via a communication line 108. Note that the server 100 is an example of an “information processing apparatus”. Also, the client PC will be referred to simply as a client hereinafter. In addition, the input/output device will also be referred to as an image forming apparatus 102 hereinafter.

The image forming apparatus 102 is connected to an external communication line via a communication apparatus 105. The home 101 is occupied by a parent or guardian and a student who are subscribers 103 of this system. The subscribers can then use print content 104 output from the image forming apparatus 102 or load the print content 104 into the image forming apparatus 102.

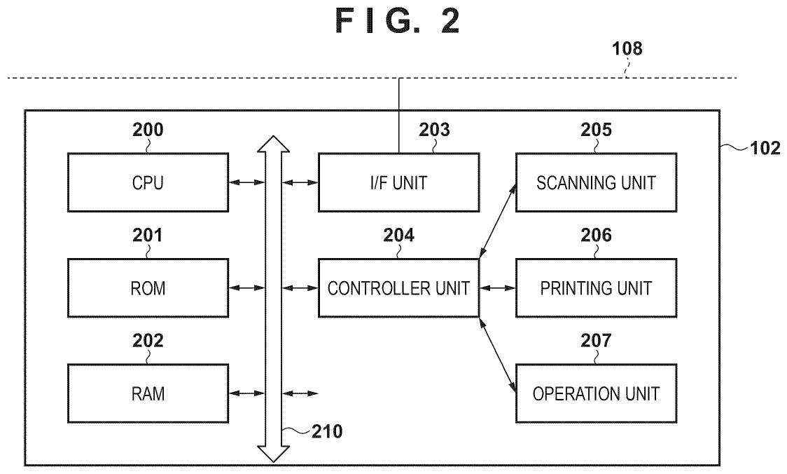

A hardware configuration of the image forming apparatus 102 will be described with reference to FIG. 2. The image forming apparatus 102 includes a CPU 200, a ROM 201, a RAM 202, an I/F unit 203, a controller unit 204, a scanning unit 205, a printing unit 206, and an operation unit 207. Note that the printing unit 206 is an example of a “forming unit”. In addition, the scanning unit 205 is an example of an “obtaining unit”.

The CPU 200 operates based on a control program and the like stored in the ROM 201. The CPU 200 outputs an image signal serving as output information to a printing unit 206 connected to the controller unit 204 via a system bus 210. In addition, the CPU 200 can communicate with the outside via the I/F unit 203, and can transmit information in the image forming apparatus 102 to the external server 100 or the like. The CPU 200 can also receive output data to be output to the printing unit 206 via the I/F unit 203.

The RAM 202 is a memory that functions as the main memory of the CPU 200, a work area, and the like. Note that the RAM 202 is used as an output information development region, an environment data storage region, a nonvolatile memory, or the like. The I/F unit 203 includes a communication module, and enables communication with the outside. The controller unit 204 performs control of the scanning unit 205, the printing unit 206, and the operation unit 207. The scanning unit 205 reads a printed surface of a sheet and stores the read information in a non-volatile memory such as the RAM 202. The operation unit 207 includes a touch panel display, buttons, and the like, and enables operations for scanning or printing using the scanning unit 205 and the printing unit 206, and input of various settings for printing. Note that these constituent units are connected to one another via a system bus 210. The CPU 200 controls these constituent units via a main bus 310.

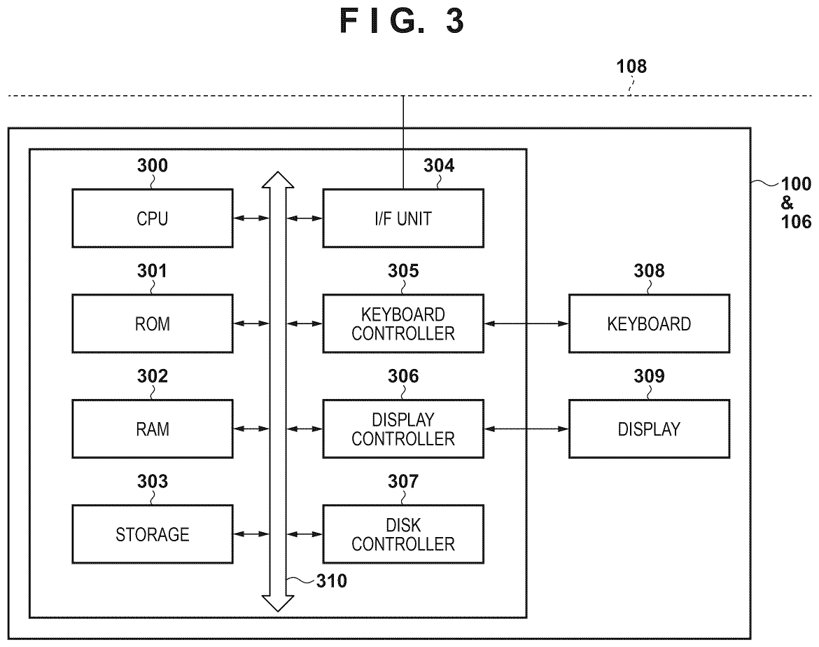

The hardware configuration of the server 100 will be described with reference to FIG. 3. Note that the client 106 also has a similar configuration. The server 100 includes a CPU 300, a ROM 301, a RAM 302, a storage 303, and an I/F unit 304. The server 100 also includes a keyboard controller 305, a display controller 306, a disk controller 307, a keyboard 308, and a display 309.

The CPU 300 reads out various programs such as control programs, system programs, and application programs from the storage 303 via the disk controller 307 to the RAM 302. The CPU 300 then performs the various programs read out to the RAM 302 to perform various types of data processing. Alternatively, the CPU 300 performs display control of the display 309. Note that the CPU 300 may read out the control program and the like from the ROM 301. The CPU 300 may also be a dedicated circuit such as an ASIC. The CPU 300 and the dedicated circuit are examples of a hardware circuit and a hardware processor.

The disk controller 307 controls access between the CPU 300 and the storage 303. The RAM 302 is configured such that its capacity can be expanded by adding an optional RAM (not shown) or the like, and is mainly used as a work area for the CPU 300. The keyboard controller 305 controls key input from the keyboard 308 or a pointing device (not shown). The display controller 306 performs display control of the display 309. In addition, the I/F unit 304 (an example of a “communication unit capable of communicating with an image forming apparatus”) includes a communication module, and is capable of communicating with the outside. These constituent units are connected to each other via the main bus 310. The CPU 300 controls these constituent units via the main bus 310.

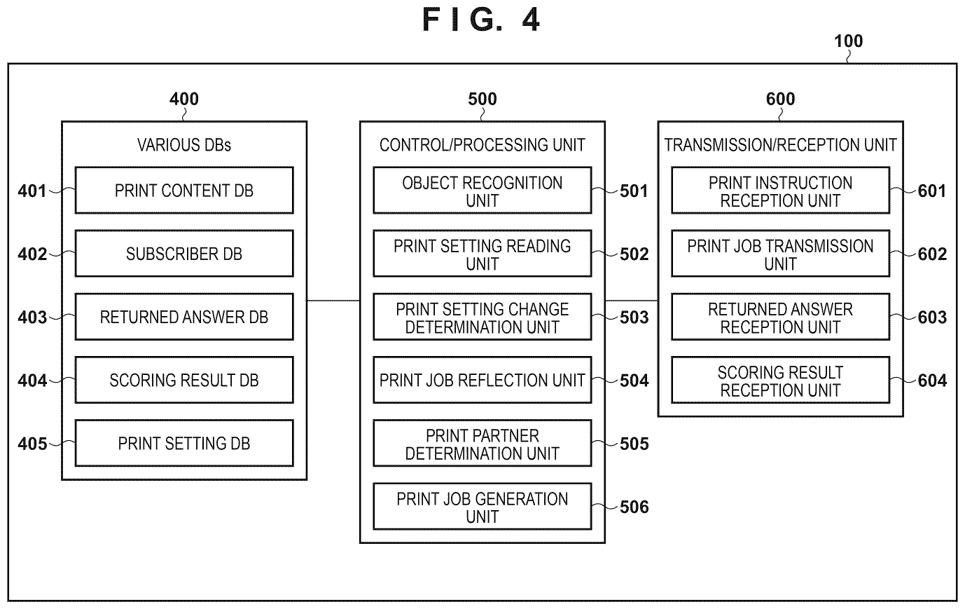

Functional blocks of the server 100 will be described with reference to FIG. 4. These functional blocks are realized by the CPU 300 of the server 100 performing various programs read out to the RAM 302. The server 100 broadly includes the functions of various DBs 400, a control/processing unit 500, and a transmission/reception unit 600. The various DBs 400 include a print content DB 401, a subscriber DB 402, a returned answer DB 403, a scoring result DB 404, and a print setting DB 405. The print content DB 401 stores print content that can be selected when a teacher or a business designates print content using the client 106. The print content covers, for example, subjects, units, and levels.

The subscriber DB 402 stores a subscriber ID of the subscriber 103, a subscriber name including parent or guardian name and student name, and a destination address of the image forming apparatus 102 used by the subscriber 103. This information is treated as registered information. The returned answer DB 403 stores the answer sheet data returned from all of the subscribers 103. Note that the answer sheet data is, for example, scan data read by a scanner.

The scoring result DB 404 stores history information of the results of the teacher scoring the answer sheets returned by all of the subscribers 103. The CPU 300 of the server 100 transmits the answer sheet data to the client 106. Then, the CPU of the client 106 uses a scoring result input unit 801 to receive the scoring operation of the operator 107 using the keyboard of the client 106. Then, the CPU uses a scoring result transmission unit 703 to transmit the result to the server 100. Then, the CPU 300 of the server 100 receives the result using a scoring result reception unit 604 and stores it in the scoring result DB 404. Note that the method for storing the scoring results in the scoring result DB 404 is not limited to this method. For example, if the server 100 includes an automatic scoring system, the results may be scored by the automatic scoring system, and the scored results may be automatically stored in the scoring result DB 404.

The print setting DB 405 stores all of the subscriber IDs and the print settings in the image forming apparatuses 102 linked to the subscriber IDs. Print settings are not limited to setting items such as “2 pages per sheet” or “double-sided printing”, but if there are print setting items that suit the purpose of use of the subscriber 103, such as economical printing, convenience for the subscriber will be improved.

The control/processing unit 500 includes an object recognition unit 501, a print setting reading unit 502, a print setting change determination unit 503, a print job reflection unit 504, a print partner determination unit 505, and a print job generation unit 506. The object recognition unit 501 is a processing unit that identifies the subscriber ID and distinguishes objects such as characters and line drawings from the answer sheet data, which is the scan data transmitted from the image forming apparatus 102. Note that if an automatic scoring system is employed, the object recognition unit 501 includes a function for distinguishing and recognizing characters.

The print setting reading unit 502 reads and recognizes the writing of a print setting change instruction in a predetermined area from the answer sheet data transmitted from the image forming apparatus 102. The print setting change determination unit 503 determines whether or not the print setting recognized by the reading unit 502 has been changed from the print setting associated with the subscriber ID stored in the print setting DB 405. If the print setting change determination unit 503 determines that the print setting has been changed, the print setting value stored in the print setting DB 405 is updated.

If the print setting change determination unit 503 determines that the print setting has been changed, a print job reflection unit 504 reflects the changed print setting in the print job. By this processing, the print content reflecting the print setting changed in the image forming apparatus 102 is printed. The print partner determination unit 505 determines whether the print content is for the parent or guardian or for the student who are the subscribers 103. A print job generation unit 506 converts rendering data such as print content into a data format that can be interpreted by the image forming apparatus 102, and converts it into a command.

The transmission/reception unit 600 includes a print instruction reception unit 601, a print job transmission unit 602, the returned answer reception unit 603, and a scoring result reception unit 604. The print instruction reception unit 601 receives a print instruction for print content from the client 106. This print instruction is sent from the client 106 to the server 100 by operating an application running on the client 106, for example.

The print job transmission unit 602 transmits the print job created by the print job generation unit 506 to the image forming apparatus 102. The returned answer reception unit 603 receives the answer sheet data transmitted from the image forming apparatus 102. Note that after receiving the answer sheet data, the answer sheet data is sent to each processing unit in the control/processing unit 500 and processed there. The scoring result reception unit 604 receives, from the client 106, the scoring results of the answer sheet data scored by the operator of the client 106. Note that the received scoring results are stored in the scoring result DB.

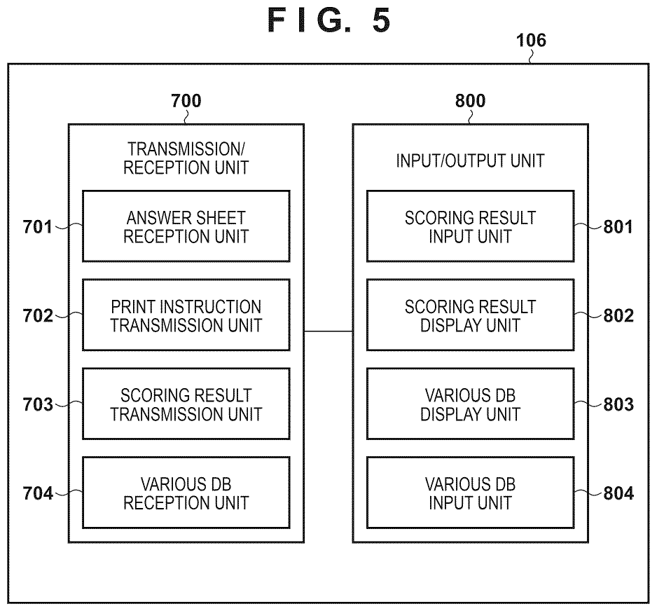

Functional blocks of the client 106 will be described with reference to FIG. 5. These functional blocks are realized by the CPU of the client 106 performing various programs read out to the RAM. The client 106 includes a transmission/reception unit 700 and an input/output unit 800. Furthermore, the transmission/reception unit 700 includes a submitted answer sheet reception unit 701, a print instruction transmission unit 702, the scoring result transmission unit 703, and a various DB reception unit 704.

The submitted answer sheet reception unit 701 is a processing unit that receives answer sheet data transmitted from the image forming apparatus 102 via the server 100. The print instruction transmission unit 702 transmits a command instructing the image forming apparatus 102 of the subscriber 103 to print the selected print content. The scoring result transmission unit 703 transmits the scoring results of the answer sheet data scored by the operator 107. The various DB reception unit 704 receives the contents of the various DBs.

The input/output unit 800 includes the scoring result input unit 801, a scoring result display unit 802, a various DB display unit 803, and a various DB input unit 804. The scoring result input unit 801 inputs the scoring result of a scored submitted answer sheet. Note that the submitted answer sheet is a sheet received by the submitted answer sheet reception unit 701. The scoring result display unit 802 displays the scoring results received by the various DB reception unit 704 for each subscriber 103. Note that the scoring results are stored in the scoring result DB 404. By viewing such a scoring result, the subscriber 103 can also check the scoring history. The subscriber 103 can then use the scoring results mainly for selection of future print content and for study plan creation.

The various DB display unit 803 displays the print content DB 401, the subscriber DB 402, the returned answer DB 403, and the print setting DB 405. The subscriber 103 can check the contents of the various DBs displayed in this way. The various DB input unit 804 is an input unit for editing data in various DBs. Data editing is input using, for example, a dedicated application, but there is no limitation to this method.

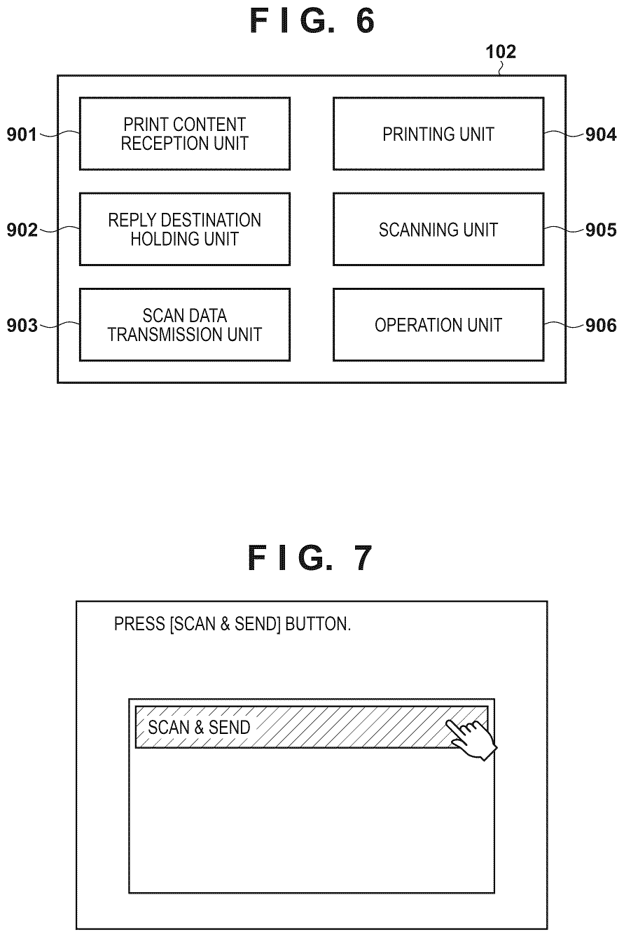

Functional blocks of the image forming apparatus 102 will be described with reference to FIG. 6. These functional blocks are realized by the CPU 200 of the image forming apparatus 102 executing various programs read out to the RAM 202. The image forming apparatus 102 includes a print content reception unit 901, a reply destination holding unit 902, a scan data transmission unit 903, a printing unit 904, a scanning unit 905, and an operation unit 906. The print content reception unit 901 receives a print job including print content transmitted from the server 100.

The reply destination holding unit 902 holds destination information of the server that is the reply destination of the answer sheet data scanned by the image forming apparatus 102. Note that the destination information is, for example, destination information that is set in advance in the image forming apparatus 102, or address information that is included in an identification mark such as a QR code (registered trademark) that is marked on the print content. The scan data transmission unit 903 transmits the scanned answer sheet data to the destination held in the reply destination holding unit 902. The printing unit 904 actually performs printing processing for the received print job using a print engine. The scanning unit 905 shines light onto the paper answer sheet, measures the intensity and color of the reflected light, and combines this data to create image data of the entire document. The operation unit 906 is used by the student that is the subscriber 103 to input an operation for scanning the answer sheet, and operations related to printing and scanning.

An example of a display on the operation panel when a scan operation is input via the operation unit 906 in FIG. 6 in the image forming apparatus 102 will be described with reference to FIG. 7. The screen of the operation panel shows that the student, who is the subscriber 103, can scan the answer sheet and transmit it to the server 100. When the student sees this screen, they place their answer sheet on the scanner and touch the “scan & send” button displayed on the screen. Then, the CPU 300 of the image forming apparatus 102 performs scanning using the scanning unit 905. Then, the CPU 200 uses the reply destination holding unit 902 to obtain the destination of the scan data. Then, the CPU 200 transmits the scan data to the server 100 using the scan data transmission unit 903.

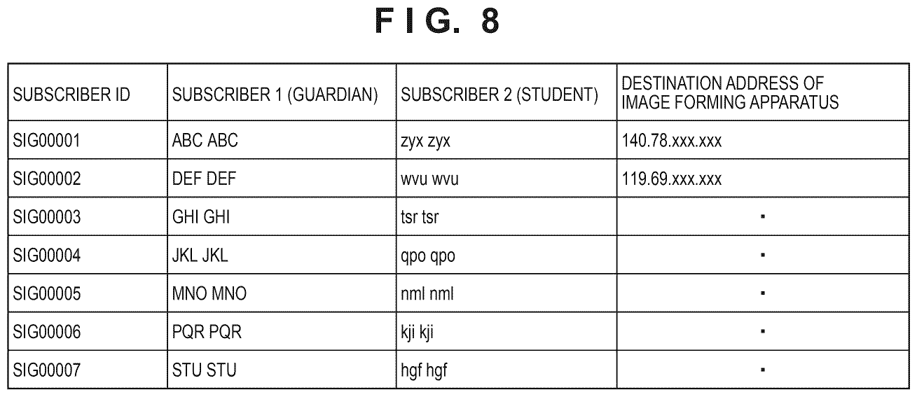

The data structure of the subscribers stored in the subscriber DB 402 of FIG. 4 will be described with reference to FIG. 8. In the subscriber DB 402, the name of a subscriber 1 (parent or guardian), the name of a subscriber 2 (student), and the destination address of the image forming apparatus 102 owned by the subscribers are registered for each subscriber ID. The editing of this subscriber DB can be performed by the various DB input units described in the client 106 of FIG. 5.

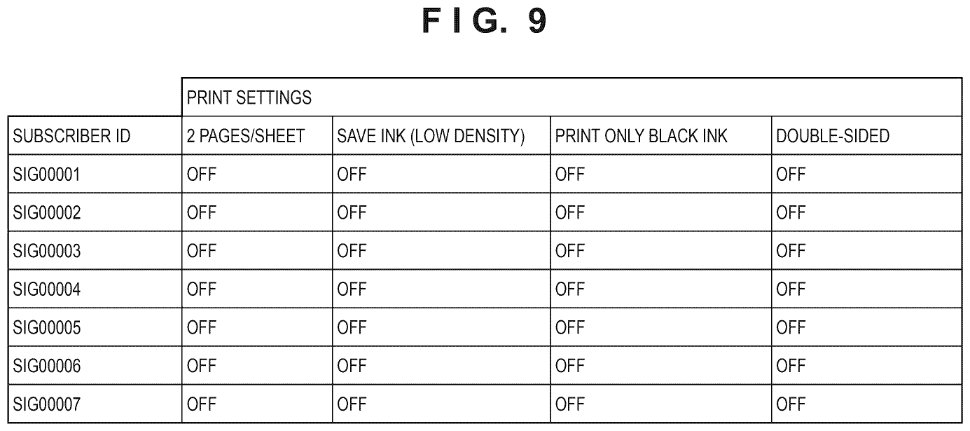

The print setting items stored in the print setting DB 405 in FIG. 4 will be described with reference to FIG. 9. The print setting DB 405 stores values indicating the setting state (ON/OFF) for saving sheets, such as “2 pages per sheet” for printing two pages on one side of a print sheet, or “double-sided” for printing on both sides of a print sheet, for each subscriber ID. The print setting DB 405 also stores values indicating the setting state (ON/OFF) for saving ink, such as “save ink (low density)” and “print only black ink”.

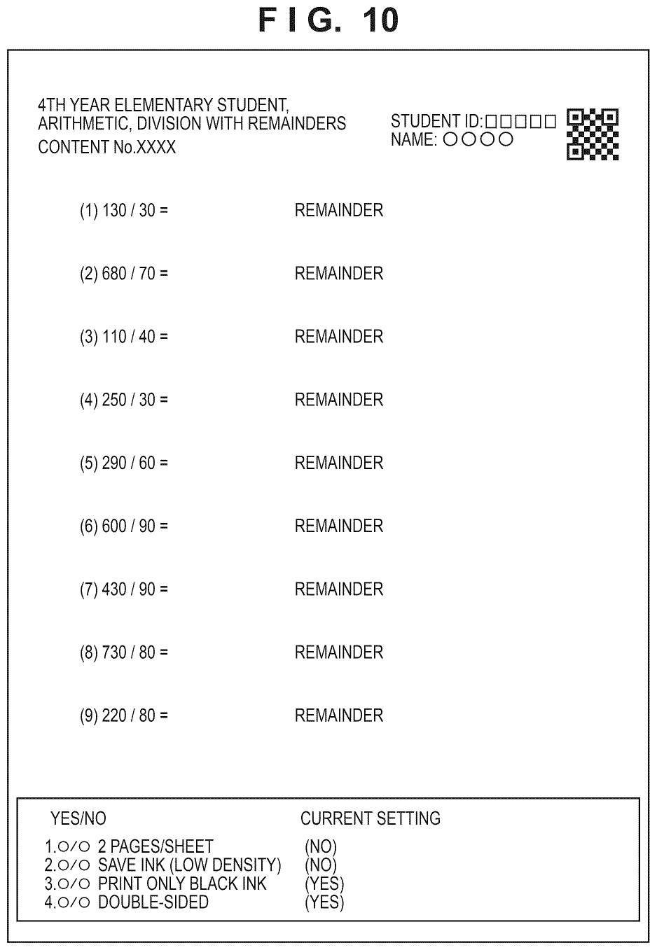

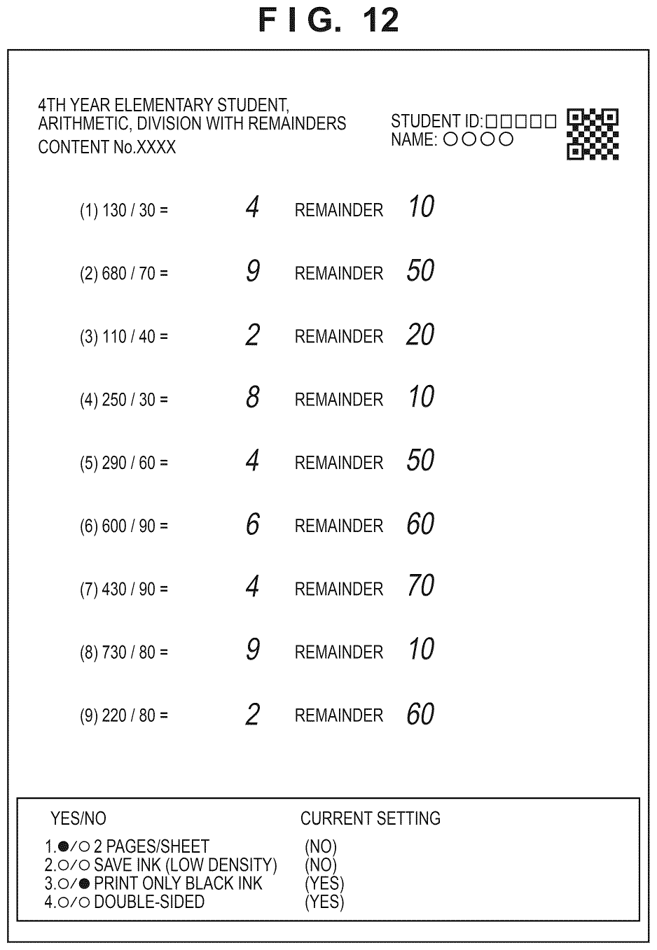

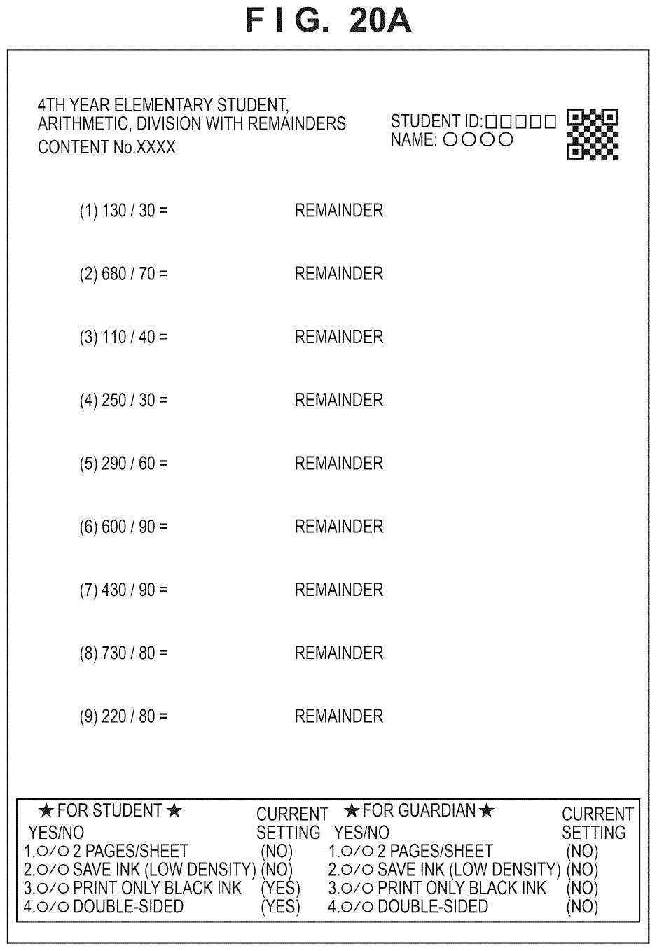

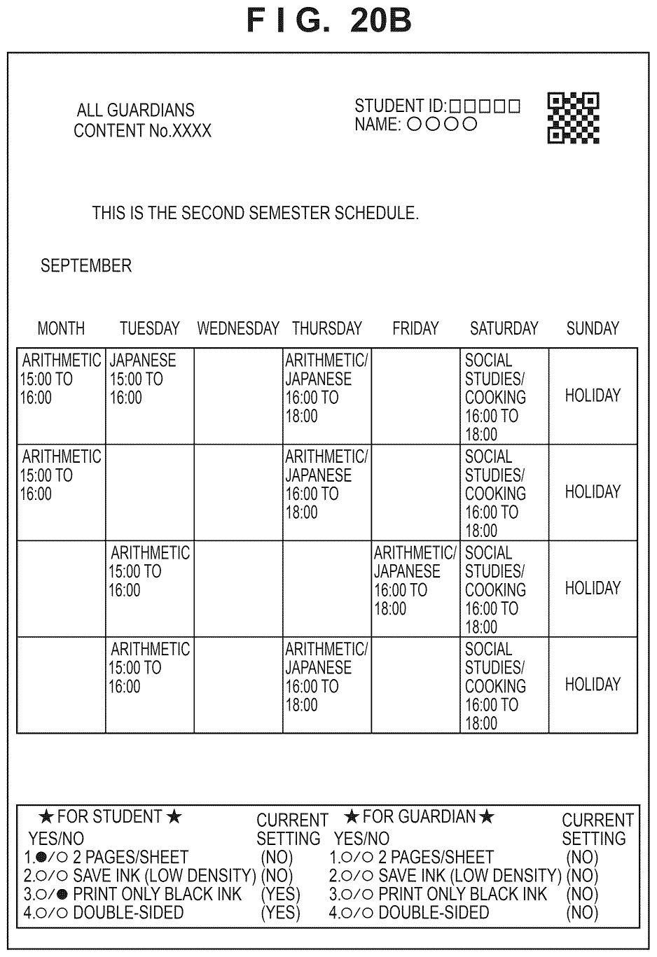

The print content will be described with reference to FIG. 10. The print content is, for example, an assignment printout on which answers can be written. At the top of the assignment printout, for example, the title of the content and the content number are written. In addition, an identification mark such as a QR code containing, for example, the subscriber ID and the student's name, as well as the subscriber ID, content number, or reply destination address, are printed on the upper right of the assignment printout. Note that the subscriber ID is an example of “user identification information”, the content number is an example of “content identification information”, and the reply destination address is an example of an “address on the network of the information processing apparatus”. Also, the QR code shown in FIG. 10 is an example (the same applies to FIGS. 12, 20A, and 20B).

In addition, calculation problems are written in the center of the assignment printout. Furthermore, below that, if a student wishes to change the print settings, a change check form is provided in which a change item can be recognized by the student inputting a checkmark. Additionally, the current print settings are recognizably printed on the right side of the form. Such a form allows the student to check the current print settings if they wish to change them. Note that the description format of the current print settings is not limited to the example shown in FIG. 10. This form is also an example of a “region where settings can be written in”.

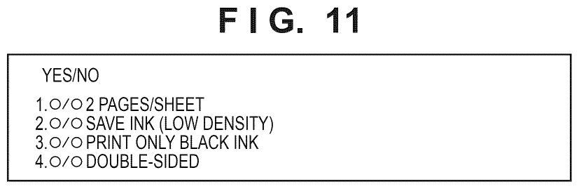

FIG. 11 is an enlarged view of the print setting change check form in FIG. 10. Note that this change check form may be printed on the print content in advance as shown in FIG. 10. Alternatively, it may be printed on a dedicated sticker and given to the student in advance. In such a case, the student may attach the sticker to the answer sheet with the changes written in. A form to which such a sticker can be attached is an example of a “region to which a sticker with settings written thereon can be attached”.

In the form, the change checklist items are, for example, numbered 1 to 4. For each item, the function is turned on when the “○” on the left side in “○/○” is changed. On the other hand, the function is turned off if the “○” on the right side is changed. That is, the student blacks out the “○” of the item they wish to change. For example, blacking out the circle on the left indicates changing the setting for that item from OFF to ON. If both remain “○”, it will be considered as no change. The print setting reading unit 502 of the server 100 reads the “○” and black circle for each of the items numbered 1 to 4. Then, a print setting change determination unit 503 determines whether or not to change the print setting using the read data. Note that the determination of a change to the print settings is not limited to the form shown in FIG. 11 or the above-described method, so long as the change to the print settings can be determined by reading the answer sheet.

An example of the assignment printout of FIG. 10 with the answers written thereon will be described with reference to FIG. 12. As shown in FIG. 12, the student writes their answers in the center of the assignment printout. Additionally, at the bottom of the assignment printout, any print settings that the student wishes to change are marked with black circles. The student sets the assignment printout in this state on the scanner and touches “scan & send” on the operation panel screen shown in FIG. 7.

### Processing Example 1

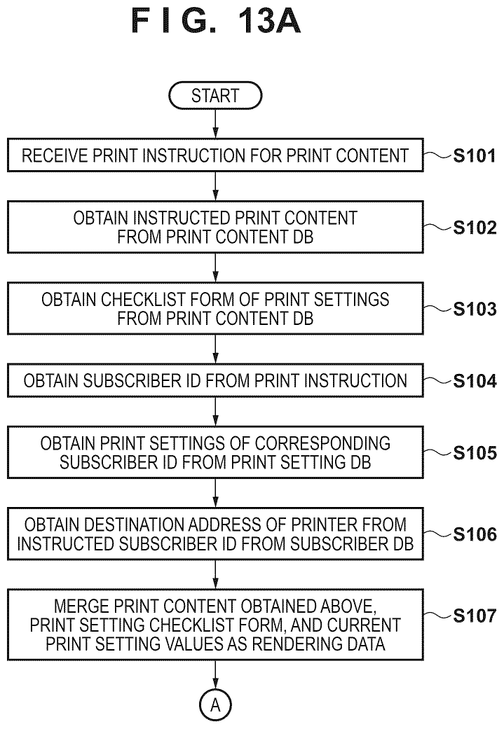

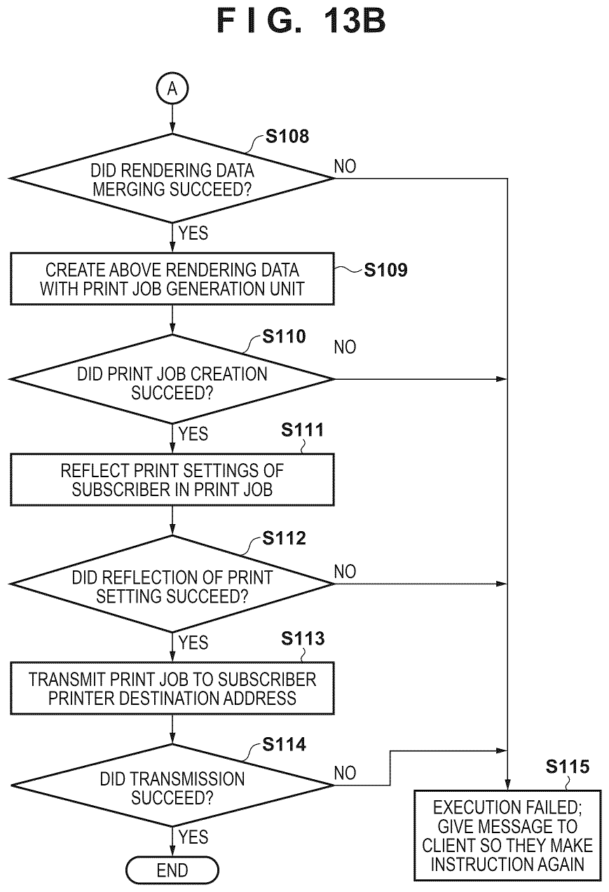

With reference to FIGS. 13A and 13B, processing in which the server 100 transmits the answer sheet including the checklist form for print settings shown in FIG. 10 to the image forming apparatus 102 will be described. Note that this processing is realized by the CPU 300 of the server 100 reading out a program stored in a storage medium such as the ROM 301 and controlling the above-mentioned constituent units.

In step S101, the CPU 300 of the server 100 receives a print instruction for print content from the client 106 using the print instruction reception unit 601. In step S102, the CPU 300 obtains, from the print content DB 401, the print content of the number for which the printing instruction was issued. In step S103, the CPU 300 obtains a checklist form for print settings from the print content DB 401.

In step S104, the CPU 300 obtains the subscriber ID included in the print instruction. In step S105, the CPU 300 obtains the print setting items corresponding to the subscriber ID from the print setting DB 405. In step S106, the CPU 300 obtains, from the subscriber DB 402, the destination address of the image forming apparatus 102 corresponding to the subscriber ID. In step S107, rendering data is generated that describes the print content obtained in step S102, the checklist form for the print settings obtained in step S103, and the current setting values for the print settings obtained in step S105. Note that the format of the rendering data is, for example, bitmap data.

In step S108, the CPU 300 determines whether or not merging of the rendering data in step S107 was successful. If the CPU 300 determines that the merging of the rendering data was successful, the processing advances to step S109, and if not, the processing advances to step S115. In step S109, the CPU 300 uses the print job generation unit 506 to create a print job including the rendering data generated in step S107.

In step S110, the CPU 300 determines whether or not the print job has been created successfully. If the CPU 300 determines that the print job has been created successfully, the processing advances to step S111, and if not, the processing advances to step S115.

In step S111, the CPU 300 causes the print job reflection unit 504 to reflect the print settings obtained in step S105 in the print job. In step S112, the CPU 300 determines whether or not the print settings have been successfully reflected in the print job. If the CPU 300 determines that the print settings have been successfully reflected in the print job, the processing advances to step S113, and if not, the processing advances to step S115.

In step S113, the CPU 300 uses the print job transmission unit 602 to transmit the print job to the destination address of the image forming apparatus 102 of the subscriber. In step S114, the CPU 300 determines whether or not the transmission of the print job was successful. Then, if the CPU 300 determines that the transmission of the print job was successful, the processing ends. Note that this print job is received by the print content reception unit 901 of the image forming apparatus 102. Then, the printing unit 904 in the image forming apparatus 102 performs the print job.

On the other hand, if the CPU 300 determines in step S112 that the print settings have not been successfully reflected in the print job, the processing advances to step S115. In step S115, the CPU 300 uses the I/F unit 304 to transmit, to the client 106, a message requesting another instruction from the client 106.

### Processing Example 2

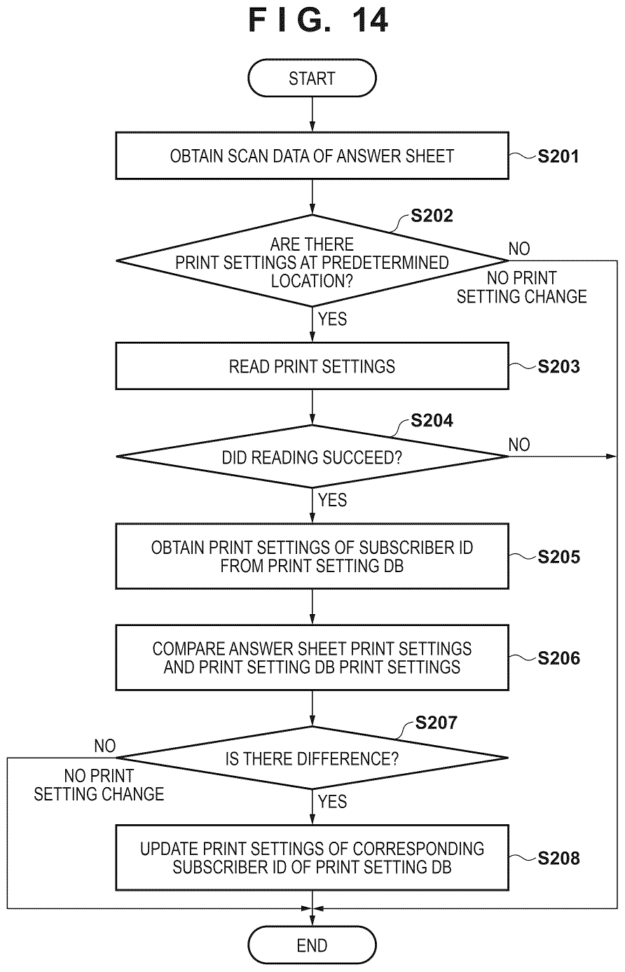

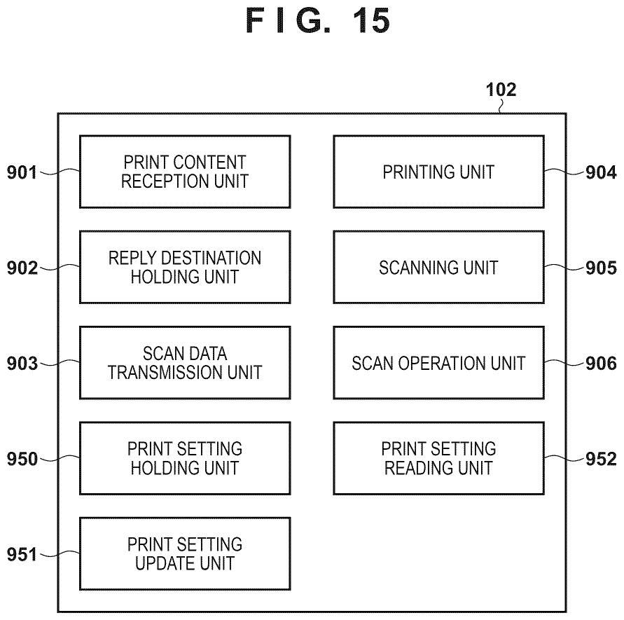

In step S105 of the above-described Processing Example 1, the CPU 300 obtains the print settings from the print setting DB 405, and the update processing of these print settings will be described below. Processing in which the server 100 reads the changes in the print settings shown in FIG. 12 from the answer sheet data in which the changes have been made will be described with reference to FIG. 14. Note that this processing is realized by the CPU 300 of the server 100 reading out a program stored in a storage medium such as the ROM 301 and controlling the above-described constituent units.

In step S201, the CPU 300 of the server 100 uses the returned answer reception unit 603 to obtain the scanned answer sheet data. At this time, if the answer sheet data includes a QR code, the subscriber ID is obtained by reading the QR code. Alternatively, if the subscriber ID is directly written in the answer sheet data, the subscriber ID can be obtained by reading this information. Note that the answer sheet data is data that is scanned by the CPU 200 (an example of a “control unit”) in the image forming apparatus 102 using the scanning unit 905, and then transmitted to the server 100 (an example of a “transmission source”) using the scan data transmission unit 903.

In step S202, the CPU 300 determines whether or not print settings are included at a predetermined position (e.g., the bottom) of the answer sheet data. If the CPU 300 determines that print settings are included, the processing proceeds to step S203. That is, for example, when the CPU 300 detects that a frame line is drawn in the answer sheet data, it determines that the print settings are included. On the other hand, if the CPU 300 determines that the print settings are not included, the CPU 300 determines that there are no changes to the print settings. In such a case, the print settings stored in the print setting DB 405 are not updated. Then, the processing ends.

In step S203, the CPU 300 uses the print setting reading unit 502 to read the print settings from the answer sheet data. In step S204, the CPU 300 determines whether or not the reading was successful. If the CPU 300 determines that the reading was successful, the processing advances to step S205. On the other hand, if the CPU 300 determines that the reading was not successful, the CPU 300 determines that there is no change in the print settings. In such a case, the print settings stored in the print setting DB 405 are not updated. Then, the processing ends.

In step S205, the CPU 300 obtains the print settings corresponding to the subscriber ID from the print setting DB 405 (an example of a “second storage unit”). In step S206, the CPU 300 uses the print setting change determination unit 503 to compare the print settings read from the answer sheet data with the print settings obtained from the print setting DB 405 for each setting item. In step S207, the CPU 300 determines whether or not there is a difference between the two as a result of the comparison in step S206. If the CPU 300 determines that there is a difference, the processing advances to step S208. On the other hand, if the CPU 300 determines that there is no difference, the CPU 300 determines that there is no change in the print settings. In such a case, the print settings stored in the print setting DB 405 are not updated. Then, the processing ends. In step S208, the CPU 300 updates the corresponding print settings in the print setting DB 405. Then, the processing ends.

### Aspect of Actions and Effects

According to the image forming system 1 as described above, a student can write their desired print settings on an answer sheet such as that shown in FIG. 10. Then, by scanning the completed answer sheet, the print settings can be easily and reliably reflected in the printed answer sheet. According to this image forming system 1, even a person with little knowledge of operating devices or software, or of changing print settings, can easily and reliably change print settings. The current print settings are also written on the answer sheet. Therefore, by checking the current print settings, the student can easily and reliably change the print settings.

### First Modification

In the above-described embodiment, the print settings are sent from the image forming apparatus 102 to the server 100 and held in the server 100. On the other hand, in the first modification, the print settings are read by the image forming apparatus 102 and held in the image forming apparatus 102.

The functional blocks of the image forming apparatus 102 according to the first modification will be described with reference to FIG. 15. The print content reception unit 901 to the operation unit 906 are similar to the blocks in the image forming apparatus 102 according to the embodiment, and therefore description thereof will be omitted. In addition to these functional blocks, the image forming apparatus 102 according to the first modified example includes a print setting holding unit 950, a print setting update unit 951, and a print setting reading unit 952.

The print setting holding unit 950 stores the print settings in a storage medium such as the RAM 202 of the image forming apparatus 102. The print setting reading unit 952 reads the print settings included in the answer sheet data scanned by the scanning unit 905. The print setting update unit 951 determines whether or not there is a difference between the print settings held by the print setting holding unit 950 and the print settings read by the print setting reading unit 952. If the print setting update unit 951 determines that there is a difference, the print setting update unit 951 causes the print setting holding unit 950 to hold the print settings read by the print setting reading unit 952. In addition, the print setting update unit 951 updates the print settings of the print job to the print settings read by the print setting reading unit 952. In this way, the print settings are updated.

### Processing Example 3

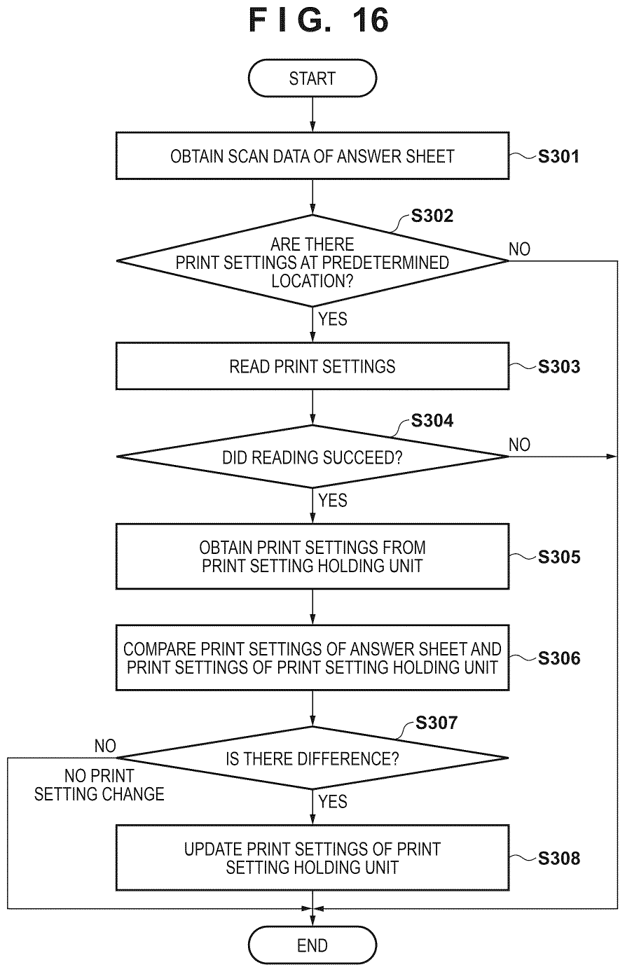

With reference to FIG. 16, processing for reading changes to print settings from answer sheet data in which the changes are described in the image forming apparatus 102 will be described. Note that this processing is realized by the CPU 200 of the image forming apparatus 102 reading out a program stored in a storage medium such as the ROM 201 and controlling the above-described constituent units.

In step S301, the CPU 200 uses the scanning unit 905 to obtain scan data of the answer sheet. In step S302, the CPU 200 determines whether or not print settings are written at a predetermined location (e.g., at the bottom) on the answer sheet. If the CPU 200 determines that the print settings are written, the processing advances to step S303, and if not, the print settings are not updated and the processing ends.

In step S303, the CPU 200 uses the print setting reading unit 952 to read the print settings from the scan data. In step S304, the CPU 200 determines whether or not the reading was successful. If the CPU 200 determines that the reading was successful, the processing advances to step S305, and if not, the print settings are not updated and the processing ends. In step S305, CPU 200 obtains print settings that have already been held in the print setting holding unit 950 (an example of a “first storage unit”).

In step S306, the CPU 200 compares the print settings read in step S303 with the print settings obtained in step S305. In step S307, the CPU 200 uses the print setting update unit 951 to determine whether or not there is a difference between the print settings read in step S303 and the print settings obtained in step S305. If the CPU 200 determines that there is a difference, the processing advances to step S308, and if not, the print settings are not updated and the processing ends. In step S308, the CPU 200 uses the print setting update unit 951 to update the print settings held in the print setting holding unit 950 with the print settings read in step S303. In this way, the print settings are updated.

### Processing Example 4

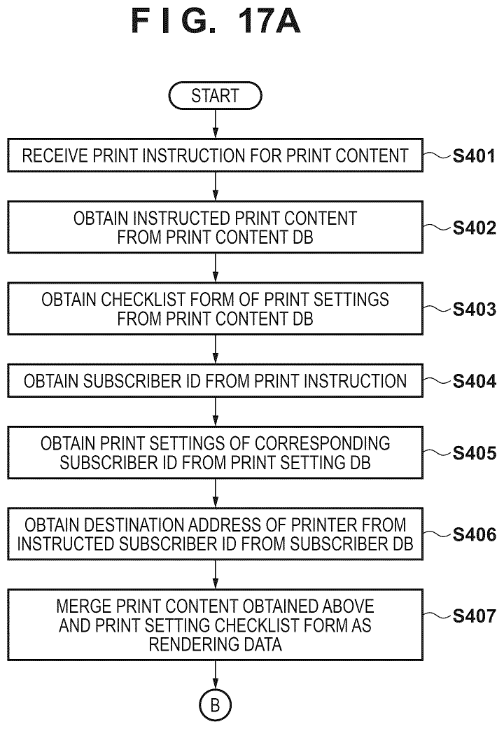

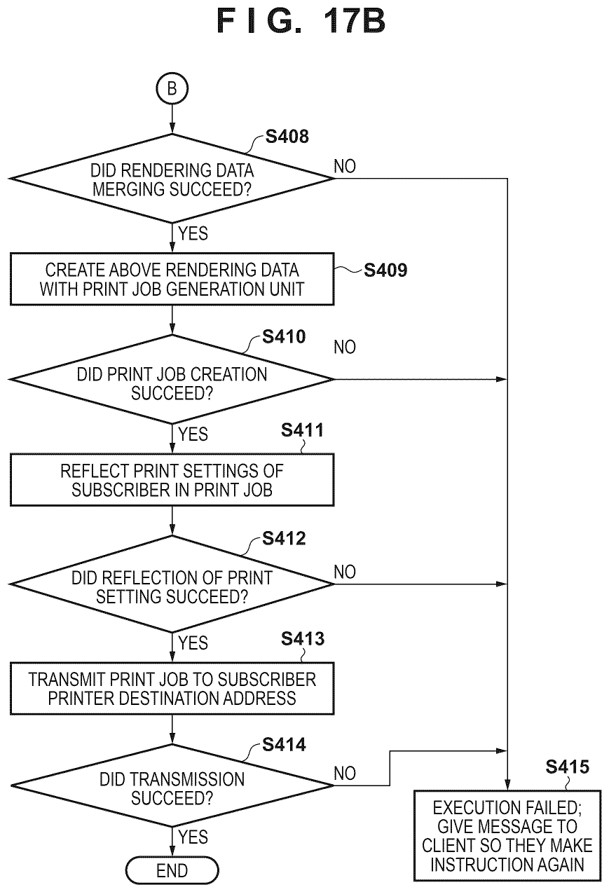

Processing for transmitting the answer sheet from the server 100 to the image forming apparatus 102 according to the first modification will be described with reference to FIGS. 17A and 17B. This answer sheet includes a checklist form for print settings. Note that this processing is realized by the CPU 300 of the server 100 reading out a program stored in a storage medium such as the ROM 301 and controlling the above-described constituent units.

Steps S401 to S406 and S408 to S415 shown in FIGS. 17A and 17B are the same as steps S101 to S106 and S108 to S115 shown in FIGS. 13A and 13B, respectively. On the other hand, in the first modification, the print settings are read by the image forming apparatus 102 and held in the image forming apparatus 102 as shown in FIG. 16. In view of this, in the first modification, the objects to be merged as rendering data in step S407 are the print content and the checklist form for the print settings. That is, the current settings of the print settings are not merged as rendering data.

### Processing Example 5

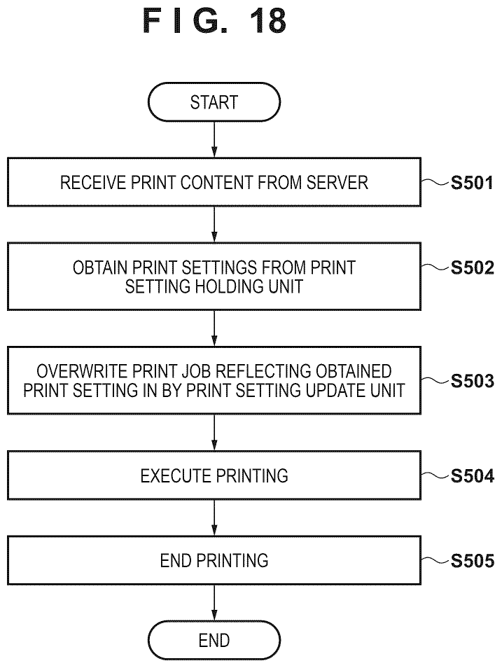

The printing processing of the image forming apparatus 102 according to the first modification will be described with reference to FIG. 18. Note that this processing is realized by the CPU 200 of the image forming apparatus 102 reading out a program stored in a storage medium such as the ROM 201 and controlling the above-described constituent units.

The CPU 200 of the image forming apparatus 102 receives print content from the server 100 using the print content reception unit 901. In step S502, the CPU 200 obtains the print settings held in the print setting holding unit 950. Then, CPU 200 uses the print setting update unit 951 to overwrite the print settings included in the print job with the obtained print settings. In step S504, the CPU 200 performs printing of the print content using the printing unit 904. In step S505, the CPU 200 ends printing while maintaining the updated print settings.

### Aspect of Actions and Effects

According to the image forming system 1 of the first modification, in addition to the effects of the above-described embodiment, even if the image forming apparatus 102 has already received a plurality of print jobs, a change to print settings can be reflected starting from a print job other than the first print job.

### Second Modification

Although the print content in the above-described embodiment is intended for a student, there may also be a case where the client 106 issues an instruction to transmit print content for a parent or guardian and print content for a student, respectively. In view of this, in the second modification, print settings are set for both a parent or guardian and a student.

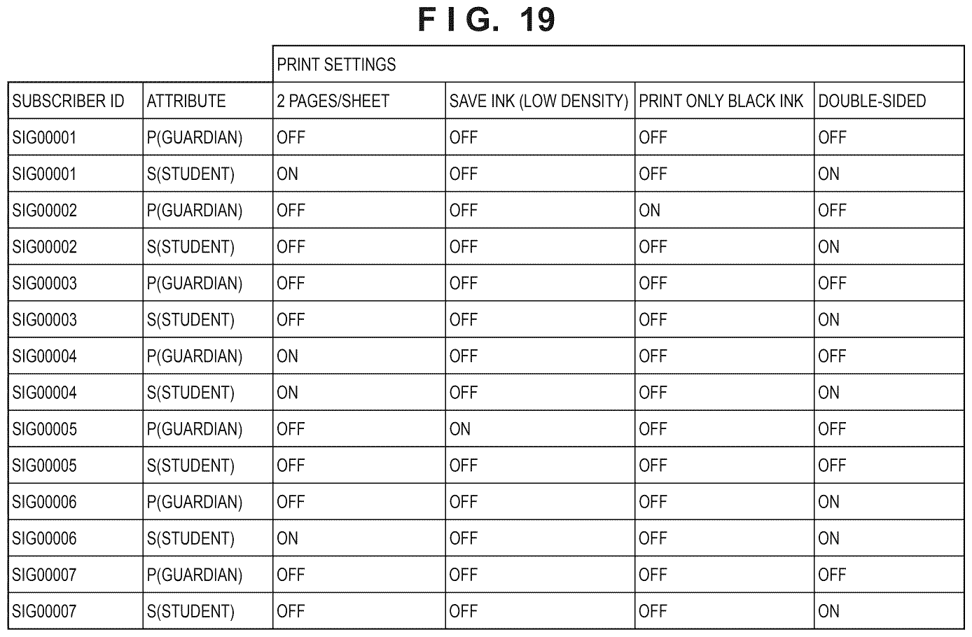

The print setting items stored in the print setting DB 405 according to the second modification will be described with reference to FIG. 19. The print setting DB 405 according to the second modification manages print settings in association with the subscriber ID, as in the embodiment (FIG. 9). In addition, the print setting DB 405 according to the second modification also manages attribute information of the subscriber (an example of a “user attribute”) in association with the subscriber ID. That is, attributes of the subscriber ID are, for example, a parent or guardian (P attribute) or a student (S attribute). Then, print settings are managed in association with each piece of attribute information.

The print content for the parent or guardian and the print content for the student will be described with reference to FIGS. 20A and 20B. FIG. 20A illustrates the print content for the student. The print content is, for example, an answer sheet, and a checklist form for print settings is written below the print content. However, this form differs from the form according to the embodiment in that the setting items for the student and the setting items for the parent or guardian are written separately. Such a form allows the student and the parent or guardian to change the print settings individually.

On the other hand, FIG. 20B illustrates an example of the print content for the parent or guardian. The print content is, for example, a student timetable contact sheet, and a checklist form for print settings is written at the bottom of the print content. This form is the same as the form described in the content for the student shown in FIG. 20A.

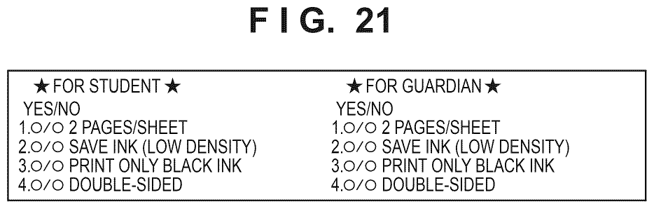

FIG. 21 is a partial enlarged view of the checklist form for print settings of FIGS. 20A and 20B. Here, differences between this form and the form shown in FIG. 11 will be described. That is, the first line of this form contains the character strings “for student” and “for parent or guardian”. In addition, star marks are written on both sides of each of these character strings. The CPU 300 of the server 100 recognizes whether the settings written in the first and second halves of the line are print settings for the student or print settings for the parent or guardian by reading these character strings and marks. Note that the print contents in FIGS. 20A and 20B are transmitted from the server 100 to the image forming apparatus 102. This transmission is realized by performing a flow obtained by replacing the answer sheet with the print content in FIGS. 13A and 13B, for example.

### Processing Example 6

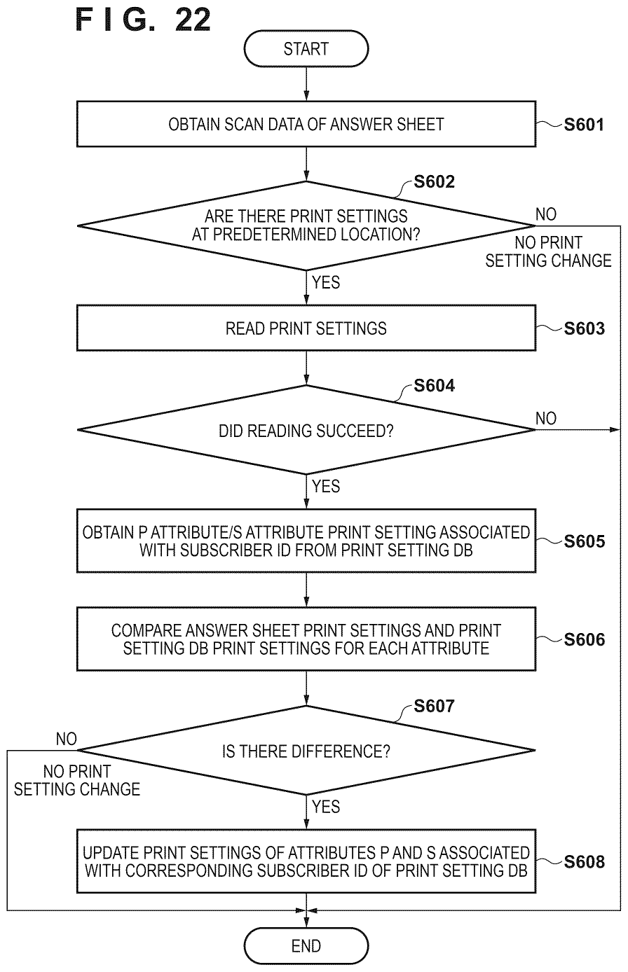

Processing in which the server 100 reads the print setting changes from the print content will be described with reference to FIG. 22. This processing differs from the processing shown in FIG. 14 in that print setting changes written for each attribute of the subscriber are read. Note that this processing is realized by the CPU 300 of the server 100 reading out a program stored in a storage medium such as the ROM 301 and controlling the above-described constituent units.

Steps S601 to S604 are the same as steps S201 to S204 in FIG. 14, and therefore the description thereof is omitted. In step S605, the CPU 300 obtains the print settings for the P attribute and the S attribute of the subscriber ID from the print setting DB 405. In step S606, the CPU 300 uses the print setting change determination unit 503 to compare the two types of print settings for the P attribute and the S attribute obtained from the answer sheet with the print settings for the P attribute and the S attribute obtained from the print setting DB 405.

In step S607, the CPU 300 determines whether or not there is a difference between the two as a result of the comparison in step S606. If the CPU 300 determines that there is a difference, the processing advances to step S608. On the other hand, if the CPU 300 determines that there is no difference, the CPU 300 determines that there is no change in the print settings. In step S608, the CPU 300 updates the print settings of the P attribute and the S attribute in the print setting DB 405 according to the difference. Then, the processing ends.

### Processing Example 7

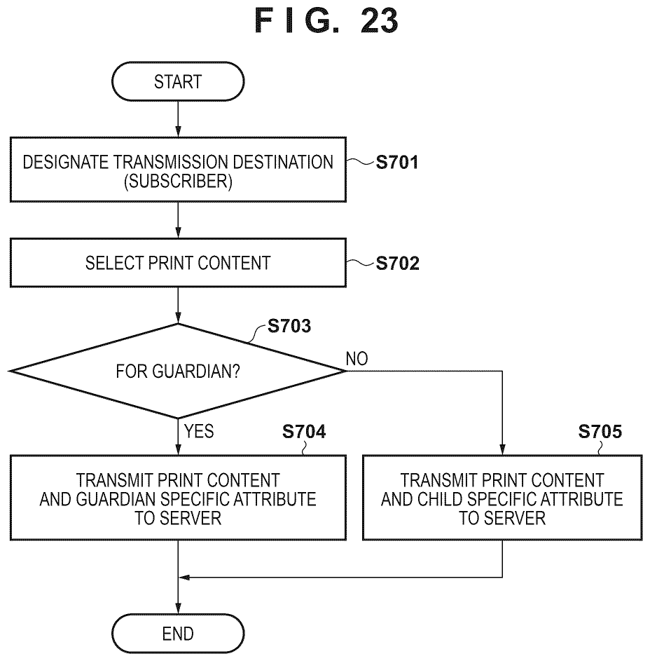

Processing in which the client 106 issues a print instruction for print content for the parent or guardian or the student will be described with reference to FIG. 23. Note that this processing is realized by the CPU of the client 106 reading out a program stored in a storage medium such as a ROM and controlling the above-described constituent units.

In step S701, the CPU of the client 106 designates the address of the image forming apparatus 102 of the subscriber as the transmission destination included in the instruction content. Note that the data of the transmission destination is extracted from the subscriber DB 402 that the various DB reception unit 704 has received from the server 100 in advance. In step S702, the CPU selects print content for which transmission is instruction. Note that the print content is selected from the print content DB 401 that the various DB reception unit 704 has received from the server 100 in advance.

In step S703, the CPU determines whether or not the selected print content is for the parent or guardian. If the CPU determines that the content is for the parent or guardian, the processing advances to step S704. In step S704, the CPU uses the print instruction transmission unit 702 to transmit, to the server 100, information including the print content, information indicating that the print content has the P attribute, and an instruction to print the print content.

On the other hand, if the CPU determines in step S703 that the print content is not for the parent or guardian, the CPU determines that the print content is for the student, and the processing advances to step S705. In step S705, the CPU uses the print instruction transmission unit 702 to transmit, to the server 100, information including the print content, information indicating that the print content has the S attribute, and an instruction to print the print content. Then, the processing ends.

Note that instead of steps S703 to S705, the CPU may use the print instruction transmission unit 702 to transmit, to the server 100, information including the print content and the instruction to print the print content. In such a case, the processing in FIG. 23 is processing in which the client 106 according to the embodiment transmits, to the server 100, an instruction to print the print content.

### Aspect of Actions and Effects

According to the image forming system 1 of the second modification, in addition to the effects of the above embodiment, changes in print settings are reflected according to the subscriber, thereby improving usability for the subscriber.

### Other Variations

The print setting items are not limited to those mentioned above. For example, the print setting items may include an item for reprinting the same print content using changed print settings. The print setting items may also include an item that prioritizes settings for the parent or guardian when the settings for the parent or guardian differ from settings for the child.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-202615, filed Nov. 20, 2024, which is hereby incorporated by reference herein in its entirety.

What is claimed is:

1. An image forming apparatus comprising:
one or more memory devices that store a set of instructions; and
one or more processors that execute the set of instructions to:
receive, from an information processing apparatus, an image formation instruction to form an image including a region in which a setting related to image formation is selectable;
form the image on a sheet based on the image formation instruction;
obtain, from the region, a setting selected by a user in the region on the sheet on which the image was formed;
transmit the obtained setting to the information processing apparatus;
receive, from the information processing apparatus, another image formation instruction in which the transmitted setting was reflected; and
form the image on another sheet based on the received other image formation instruction.

2. The image forming apparatus according to claim 1, wherein
the region includes an area for the user to select the setting related to image formation, and
the setting is selected by the user filling in the area.

3. The image forming apparatus according to claim 1, wherein
the region includes a plurality of areas for the user to select a plurality of settings related to image formation, and
when the user fills in an area among the plurality of areas, the setting corresponding to the filled-in area is selected from the plurality of settings.

4. The image forming apparatus according to claim 1, wherein
the setting includes a page layout setting.

5. The image forming apparatus according to claim 1, wherein
the setting includes a setting related to saving of recording material for forming the image.

6. The image forming apparatus according to claim 1, wherein
the setting includes a double-sided printing setting.

7. A control method for an image forming apparatus, comprising:
receiving, from an information processing apparatus, an image formation instruction to form an image including a region in which a setting related to image formation is selectable;
forming the image on a sheet based on the image formation instruction;
obtaining, from the region, a setting selected by a user in the region on the sheet on which the image was formed;
transmitting the obtained setting to the information processing apparatus;
receiving, from the information processing apparatus, another image formation instruction in which the transmitted setting was reflected; and
forming the image on another sheet based on the received other image formation instruction.

8. A non-transitory computer-readable storage medium storing a program for causing a computer to perform each step in a control method for an image forming apparatus, the control method comprising:
receiving, from an information processing apparatus, an image formation instruction to form an image including a region in which a setting related to image formation is selectable;
forming the image on a sheet based on the image formation instruction;
obtaining, from the region, a setting selected by a user in the region on the sheet on which the image was formed;
transmitting the obtained setting to the information processing apparatus;
receiving, from the information processing apparatus, another image formation instruction in which the transmitted setting was reflected; and
forming the image on another sheet based on the received other image formation instruction.
